(19) United States
(12) Patent Application Publication
(10) Pub. No.: US 2016/0335484 A1
(43) Pub. Date: Nov. 17, 2016

(54) ACCESS POINT STREAM AND VIDEO SURVEILLANCE STREAM BASED OBJECT LOCATION DETECTION AND ACTIVITY ANALYSIS

(71) Applicant: Fortinet, Inc., Sunnyvale, CA (US)

(72) Inventors: Michael Xie, Palo Alto, CA (US); Robert Westendorp, Burnaby (CA); Joseph R. Mihelich, Folsom, CA (US)

(73) Assignee: Fortinet, Inc., Sunnyvale, CA (US)

(21) Appl. No.: 14/644,913

(22) Filed: Mar. 11, 2015

(51) Int. Cl. G06K 9/00; H04N 7/18; H04W 4/02; H04W 4/04; H04L 29/12

(52) U.S. Cl. CPC G06K 9/00335; H04W 4/043; H04L 61/6022; H04W 4/023; H04N 7/181; G06K 9/00778; G06K 9/00718

(57) ABSTRACT

Methods and systems for co-relating location and identity data available from Access Points (APs) and video surveillance systems are provided. According to one embodiment, data, including a unique identifier of an object and information regarding a first geo-position of the object, is received from an AP of a wireless network of a venue. A video feed captured by a camera system monitoring a portion of the venue and/or information regarding a second geo-position corresponding to the object are also received. The first and second geo-positions are then mapped to a common coordinate system. Based on the unique identifier, information regarding the object as reported by the AP and the camera system or derived therefrom are correlated. Finally, behavioral attributes of the correlated object are assessed based on one or a combination of actions of the object, the first and second geo-positions and the common coordinate system.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2015, Fortinet, Inc.

### BACKGROUND

1. Field

Embodiments of the present invention generally relate to detecting location and analyzing activity-based behavior of one or more objects. More particularly, embodiments of the present invention relate to the use of a combination of access point (AP) stream and video surveillance stream data to accurately detect the locations of one or more objects and in connection with behavior analysis of such objects for application in analytics, including, but not limited to, retail analytics.

2. Description of the Related Art

With global exposure and Internet access, today's consumers are smart and it is imperative that retail gets smarter in proactively understanding and providing personalized services to consumers. The future of retail, to a large extent, depends on how consumer trends are detected, analyzed, and suitably catered to.

Retail analytics have traditionally relied on camera systems such as video surveillance that help locate and track consumers within a retail space. Video data is captured within a camera's field of view in various resolutions and frame rates and is generally transmitted as compressed video streams over Internet Protocol (IP) based networks. Information pertaining to location and movement of consumers can be extracted from these video streams; however, the accuracy of the extracted information depends on the visual coverage of the cameras. The video coverage is limited by the number and location of the cameras deployed. Meanwhile, it is often difficult to identify consumers even when they are within a camera's field of view as a clear view of the consumer's face is required for facial recognition to be performed. Face recognition is a critical aspect of video surveillance, but typically provides best results at choke points, such as airport security screening, lobbies of corporate offices and the like. While 360° fisheye cameras can be used to increase the video coverage area, the tradeoff is typically a hampering of facial recognition as a result of reduced resolution of captured image/video. As such, simply deploying a large number of cameras or cameras with wide-angle lenses to increase coverage does not address the deficiencies of a video-based retail analytic system.

A relatively recent approach to retail analytics has been use of wireless Access Points (AP). With a growing percentage of consumers carrying smartphones, utilizing probe requests from smartphones can provide a fair idea of the location and identity of consumers. When an AP receives a probe request, it is understood that a certain wireless device is within range of the AP. This provides a fair approximation for presence detection of a consumer. If multiple APs are installed, a location can be triangulated, for example, based on the signal strength of the probe request signal measured at the APs. This technique however is limited by its ability to detect only consumers carrying smartphones. Also, the feasibility of extracting location information depends on the strength of the signal and the coverage provided by the APs. Meanwhile, in the absence of visual information, it is difficult to gauge a consumer's behavior, reactions and the like. Deductions based on information received from APs are thus limited to consumers carrying smartphones, and further, statistical analysis alone may not give a true picture in relation to the consumer's activities.

There is therefore a need in the art for an effective system and method that detects location and analyzes activities/behavior of moving objects by overcoming various drawbacks of existing techniques.

### SUMMARY

Methods and systems are described for co-relating location and identity data available from Access Points (APs) and video surveillance systems for behavioral analytics and anomaly detection applications. According to one embodiment, data, including (i) a unique identifier of an object and (ii) a first geo-position of the object or data from which the first geo-position can be derived, is received from at least one Access Point (AP) of a wireless network of a venue. A video feed captured by at least one camera system monitoring a portion of the venue and/or a second geo-position corresponding to the object are also received. The first geo-position and the second geo-position are then mapped to a common coordinate system. Based on the unique identifier for the object, information regarding the object as reported by the AP or derived therefrom and information regarding the object as reported by the camera system or derived therefrom are correlated. Finally, behavioral attributes of the correlated object are assessed based on one or a combination of actions of the object, the first geo-position, the second geo-position and the common coordinate system.

Additional aspects of the invention will be set forth in part in the description which follows, and in part will be obvious from the description, or may be learnt by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an exemplary architecture of a system for detecting presence, location and/or behavioral attributes of one or more objects in accordance with an embodiment of the present invention.

FIG. 2 illustrates exemplary functional modules of a system for detecting location, identification and/or behavioral attributes of one or more objects in accordance with an embodiment of the present invention.

FIG. 3 illustrates an exemplary block diagram showing location detection of an object, and behavior analysis thereof in accordance with an embodiment of the present invention.

FIG. 4 illustrates an exemplary block diagram showing location detection of one or more objects, and behavior analysis thereof in accordance with an embodiment of the present invention.

FIG. 5 illustrates an exemplary flow diagram for detecting a location of an object, and analyzing behavioral attributes thereof in accordance with an embodiment of the present invention.

FIG. 6 is an exemplary computer system in which or with which embodiments of the present invention may be utilized.

### DETAILED DESCRIPTION

Methods and systems are described for co-relating location and identity data available from APs and video surveillance systems for behavioral analytics and anomaly detection applications.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

The term “object” used hereinafter in the specification refers to but is not limited to a human being/user/customer, and any or a combination of a mobile phone, smart phone, laptop, and a computing device. Object can also be broadly interpreted to include any physical entity, behavior/activities of which are desired to be monitored for taking one or more measures/actions.

The term “Access Points” (APs) used hereinafter in the specification refers to, but is not limited to, wireless signal receivers pertaining to wireless technology standards including Wi-Fi, Bluetooth, Near Field Communication (NFC) and Radio Frequency Identification (RFID).

Methods and systems are described for co-relating location and identity data available from Access Points (APs) and video surveillance systems for behavioral analytics and anomaly detection applications.

An aspect of the present disclosure provides a system that can include an access point based location detection module configured to receive first geo-position data corresponding to an object from at least one Access Point (AP), wherein the first geo-position data can include a unique identifier for the object being tracked. The system can further include a video surveillance based location detection system configured to receive second geo-position data corresponding to the object from at least one camera system, wherein the second geo-position data can be extracted from video feeds from the at least one camera system. In one embodiment, the system can further include a geo-position data based mapping module configured to map the first geo-position data and the second geo-position data to a common co-ordinate system, wherein a tracking module of the system can then correlate the object reported by the video surveillance based system and match it with the object reported by the AP-based system based on the unique identifier for the object to enable behavioral attributes of the correlated object to be assessed based on one or a combination of actions of the object, the first geo-position data, the second geo-position data, and the common co-ordinate system.

In an embodiment, an object, in context of the present disclosure can refer to a person/user that is carrying one or more wireless computing devices, including, but not limited to a mobile phone, a smartphone, a tablet computer, a wearable computing device (e.g., a smartwatch, a wristband, necklace, etc.) or a laptop. Such wireless computing devices are typically configured to automatically connect with wireless networks with which they are in range. Even if they are configured not to automatically connect to the wireless network at issue, such wireless computing devices still send out a probe-request that provides a unique identifier (e.g., a Media Access Control (MAC) address of the wireless computing device). In either case, the connection request or the probe request originated by the wireless computing device allows one or more access points (APs) within an enterprise, venue, retail establishment or the like to detect the presence of the person/user based on the unique identifier of the wireless computing device embedded within the request. Since people do not often change their wireless computing devices, the unique identifier of the wireless computing device is a good approximation for the presence of a particular individual. Meanwhile, if multiple APs are installed within a particular premises, the location of the particular individual be determined by performing triangulation based on the signal strength of the request or by a similar mechanism.

According to one embodiment, the unique identifier can be used to store and retrieve behavioral/activity history of the object for assessment of the object's behavioral attributes. For instance, in an exemplary implementation, MAC addresses of one or more wireless computing devices can be stored in a database along with activities undertaken by the objects associated with the MAC addresses, which activities can be retrieved by the system whenever a behavioral analysis on any of the objects is to be performed. In an exemplary embodiment, “activities”, in context of the present invention, is to be interpreted not only to include actions performed by a person/user, say products purchased, frequency of purchase/visit to retail store, average billing pattern, behavior within retail store, average time in the store, but can also include restrictions imposed on the user by the store authorities, anomalies in user's behavior, or any other analytical information that can help take appropriate decisions/actions on/for the user.

Those skilled in the art will appreciate that although embodiments of the present invention are described with reference to generating and tracking location, identify and behavioral data with respect to a single object (e.g., a single person), in alternative embodiments, similar tracking and analysis can be conducted on a group of objects to understand, for instance, congestion and/or traffic patterns within a premises, average waiting time, preferences of one or more objects, average time spent per user, among any other desired analytical parameters. Those skilled in the art will also appreciate that although various embodiments of the present invention are described with reference to applications in the retail sector, the methods and systems for co-relating location and identity data described herein are broadly applicable to other contexts, including, but not limited to, other public or private venues (e.g., restaurants, hotels, malls, airports, stadiums, business campus, school or university campus, military base, amusement parks, resorts and country clubs) that make use of both a wireless network and a video surveillance system.

According to an embodiment, the first geo-position data can be determined by the at least one AP using a triangulation method, wherein three or more APs can be configured to detect a common object based on say its MAC address, and then compute the geographical coordinates of the object, which can then be sent back to the system to enable identification of the object along with other activity/behavior information thereof. According to another embodiment, one or more analytics can be performed to determine the second geo-position data based on a video stream from one or more camera systems to independently identify/locate the object and assess the object's behavior. According to yet another embodiment, the unique identifier and/or location information available as a result of analysis of the AP-based system can be used to augment the analysis of the video surveillance system in order to locate the object and assess the object's behavior, for example, or vice versa. As mentioned above, based on the assessed object's behavior, one or more actions can be performed. For instance, loyalty cards can be issued to a regular user, or entry restrictions can be imposed on a user that bypassed one or more security norms or when actions of a user resulted in one or more anomalies. According to another embodiment, any or a combination of the first geo-position data, the second geo-position data and other derived/measured analytical parameters and/or historical snapshots thereof can be stored in a database for all objects encountered or a subset thereof as configured by an administrator, for example.

Aspects of the present disclosure further relate to a method for co-relating location and identity data available from Access Points (APs) and video surveillance systems for behavioral analytics and anomaly detection applications. According to one embodiment, a method of behavioral/activity analysis include the steps of receiving first geo-position data corresponding to an object from at least one AP, wherein the first geo-position data can include a unique identifier for the object; receiving second geo-position data corresponding to the object from at least one camera system, wherein the second geo-position data can include video feeds from the at least one camera system; mapping the first geo-position data and the second geo-position data to a common co-ordinate system; correlating the object reported in the first geo-position data and matching it with the object reported in the second geo-position data based on the unique identifier for the object; and assessing behavioral attributes of the correlated object based on one or a combination of actions of the object, the first geo-position data, the second geo-position data, and common co-ordinate system.

An aspect of the present disclosure provides a system that can be implemented as software, hardware, firmware, or a combination thereof and configured in a computing device to communicatively couple with at least one AP stream and at least one video surveillance system stream.

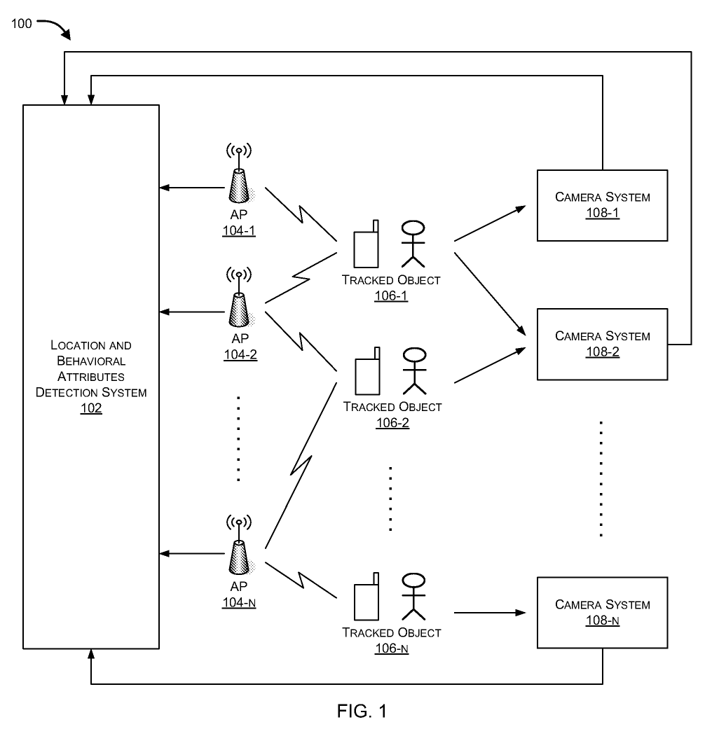

FIG. 1 illustrates an exemplary architecture 100 of a system 102 for detecting presence, location and/or behavioral attributes of one or more objects 106 in accordance with an embodiment of the present invention. In the context of the present example, system 102 seeks to achieve synergies by combining location, presence and/or identity data that may be derived from one or more access points (APs) such as 104-1, 104-2, . . . , 104-n (which may be collectively referred to as AP 104 hereinafter) and similar data that may be derived from video cameras/surveillance systems, such as 108-1, 108-2, . . . , 108-n (which may be collectively referred to as camera system 108 hereinafter) to accurately identify one or more objects of interest, assess their activities/actions, and conduct analytics thereon to control/implement desired objectives.

A high percentage of people (which may also be referred to as objects 106 hereinafter) carry wireless devices, such as smartphones, mobile phones, tablet computers, portable digital assistants (PDAs), pagers, wearable computers (e.g., smart watches), portable Global Positioning Satellite (GPS) devices, among other like devices. Even when such devices are configured not to automatically connect with wireless networks, they still send out probe requests to one or more access points (AP) 104 or other applicable network devices, wherein such requests can include Media Access Control (MAC) addresses of the devices. When APs receive these requests, they can determine that a certain wireless device is in their range, which provides a good approximation for the presence of a particular individual that is associated with the wireless device. The APs 104 may also employ location determination means (e.g., triangulation) to identify the location of the objects and also uniquely represent them through unique identifiers (e.g., their respective MAC addresses) contained within the requests.

Likewise, it is common practice for businesses, public venues, retail stores and the like to install camera systems 108 (e.g., video surveillance systems) to monitor people, wherein such systems 108 can send video streams to a database/server or any other configured computing device, which can then perform facial recognition to attempt to identify the one or more objects, evaluate their activities, and undertake analytics to assess meaningful information, including, but not limited to, average time spent in a particular location or venue, average billing time, average waiting time, quantity and/or dollar value of consumed products, congestion periods, among other desired analytic information.

In the present example, APs 104 and camera systems 108 may collectively report real-time location metrics and allied information (e.g., geo-location data/location coordinates of tracked objects 106, associated activity information of tracked objects 106, unique identifiers associated with tracked objects 106, if available from a corresponding wireless computing device, among other configured information) to location and behavioral attributes detection system 102 for behavioral analytics and anomaly detection. In cases where multiple APs are configured in an environment, location information may be a result of triangulation based on the signal strength of the probe request and/or connection request signals observed by multiple APs 104. According to an embodiment, APs 104 can be associated with at least one wireless technology standard including but not limited to IEEE 802.11x, Wi-Fi, Bluetooth, Near Field Communication (NFC) and Radio Frequency Identification (RFID).

According to one embodiment, data received from APs 104 by location and behavioral attributes detection system 102 can include a unique identifier (e.g., a MAC address of a wireless computing device) associated with each object, wherein video data received from camera systems 108 can first be co-related with AP stream data within a common coordinate system to then accurately isolate and identify one or more common objects in both the streams, wherein object(s) 106 in the video stream from camera systems 108 can then be tagged based on the unique identifier that is associated with each object information received from the AP stream. For instance, an AP stream received from say AP 104-1 by system 102 can show/represent three users User_1, User_2, and User_3, each of whom can be associated with a unique identifier, say a MAC address (UID_1, UID_2, and UID_3) such that when a video stream (showing say 10 objects) from say camera system 108-1 is received by the system 102, the system 102 can first map both the AP stream and the video stream onto a common coordinate system, and then can track each of the three users (from amongst a larger group of users/objects) in the video stream that are received in the AP stream, and the three users in the video stream can then be tagged for analysis of their behavior.

According to another embodiment, system 102 can be operatively coupled with a database/repository (not shown) that can enable system 102 to retrieve stored/historical information regarding one or more users/objects 106 based on their unique identifiers. Those skilled in the art will appreciate that although various embodiments described herein are discussed with reference to a MAC address of a wireless computing device as an example of a unique identifier, other unique or relatively unique identifiers (e.g., International Mobile Equipment Identity (IMEI), International Mobile Subscriber Identity (IMSI), INID, an iOS Unique Device Identifier (UDID), a BlackBerry PIN, an Internet Protocol (IP) address or even the list of SSIDs broadcast by a particular wireless computer device) may be used if they are available within management and/or control frames of a wireless communications protocol. Historical information can be used to conduct more detailed/comprehensive analytics on one or more objects/users 106 based on a combination of current actions of objects that are received in AP/video streams, previous activities/statistics/behavior, previous restrictions imposed, among other parameters.

System 102 of the present disclosure can be configured to combine data/streams received from AP(s) 104 (having a unique identifier for each identified tracked object 106) and camera system(s) 108 (having video feeds), and map the received streams having one or more common tracked objects 106 onto a common co-ordinate system. The system 102 can then correlate the common tracked objects 106 reported from AP 104 and camera system 108 and assess behavioral attributes of the correlated tracked objects 106. According to one exemplary implementation, as also mentioned above, each tracked object 106 sent in the AP stream can be associated with a unique identifier, and once both the streams (AP and video) are mapped on a common coordinate system, one or more objects of interest from the AP stream can be identified in the video stream and then tagged with the same or a new unique identifier in the video stream, and activities such as purchase trend, time spent, interactions done with other objects, behavior attributes, demographic attributes, of the tracked objects of interest can be evaluated to perform analytics. Furthermore, as will be appreciated by those skilled in the art, a group of two or more objects 106 can be tracked together to assess the overall store analytics for parameters such as average sale time, waiting time, congestion time, products of most interest, products of least interest, sequence of purchase, among can other parameter of interest. Similarly, when an individual object separates from a tracked group, the individual object can be tagged with information learned about behavior of the group with which the individual was a part.

Those skilled in the art will appreciate that although system 102 has been shown to be operatively coupled with APs 104 and camera systems 108, such coupling can be implemented in a variety of ways, e.g., through wired and/or wireless means, wherein system 102 can be, in an instance, configured in a remote device and APs 104 and camera systems 108 can be configured on premises where monitoring of one or more objects 106 is to be performed, wherein the APs 104/camera systems 108 can be configured to periodically or dynamically or on demand send their respective streams. Such streams, in another instance, can first be pre-processed to identify, for instance, unique identifier/location and object mapping information from AP streams, and object identification/activity analysis from the video streams. Existing video analytic means such as face recognition and audio recognition, among others can also be incorporated to assist in conducting and further improving the accuracy of behavior analytics on one or more objects 106.

According to another embodiment, location information derived from signal detection by Wi-Fi Access Points 104 can be correlated with video feeds from surveillance cameras 108 which can facilitate identification of objects (e.g., people/vehicles) that carry and/or are associated with wireless computer devices. Data derived from APs 104 and data derived from surveillance cameras 108 when co-related and analyzed together with the video feeds from the cameras can reveal patterns of specific visitors within a venue. The systems and methods described herein can therefore facilitate recognition of such patterns (e.g., who is currently within a particular venue, arrival times, departure times, detailed location/activity information), wherein such information can be used to screen regular visitors (like employees), help present anomalies (e.g., first time visitors or unauthorized visitors) to security officers for closer inspection, for instance. Embodiments of the present invention may therefore be used as data fusion architecture directed at gaining detailed data about customer behavior in a store or in similar environment.

According to one embodiment, video stream from cameras 108 can be sent as motion images covering a defined field of view in various resolutions and frame rates, wherein the method of transmitting these streams/data varies. For instance, video streams can be compressed and sent over IP based networks, wherein information contained in such streams can be recognizable by a human operator and can enable him/her to view the scene and behavior of people in the images/video. Video analytics provide an automated way to extract information based on this data from one or multiple cameras, wherein the analytics can detect the presence of people, their vehicle/unique numbers, location, and their behaviors (e.g., entering, exiting, lining up, lingering, rushing or crowding). With the use of APs 104, in addition to location information identifying information associated with people/objects 106 can also be determined based on one or more wireless computing devices being carried. For example, unique identifiers associated with a wireless computing device carried by an individual can be captured from WiFi connection requests, probe requests and/or other management or control frames originated by the wireless computing device. APs 104 can also derive statistical data about where the objects are, their concentrations in a venue, how long the objects 106 stay in a particular location or within the venue, a vehicle they own, products they purchase, among other details. Based on stored historical information, it is also possible to identify a returning customer, his/her shopping frequency, and many more variable/static parameters for a business owner or retailer. Aspects of the present disclosure therefore enable use of data derived from an AP stream in combination with a video system to perform more accurate unique identifier based video analytics, wherein the AP stream can include unique identifiers associated with one or more users and can also provide information (e.g., signal strength) from which a location can be estimated to supplement location information derived from one or more video feeds.

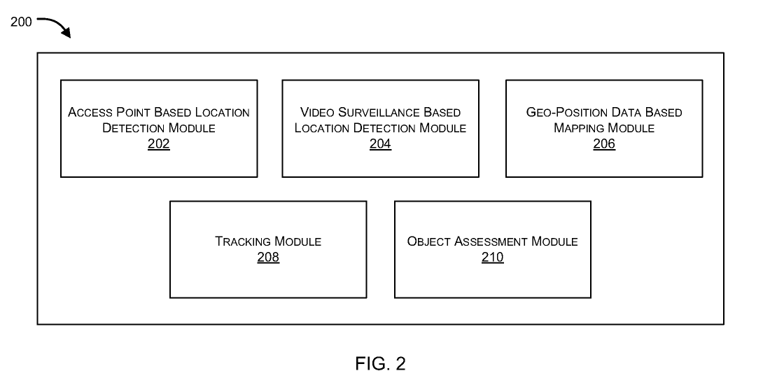

FIG. 2 illustrates exemplary functional modules of a system 200 for detecting location, identification and/or behavioral attributes of one or more objects in accordance with an embodiment of the present invention. System 200 can receive inputs (e.g., raw, processed and/or derived data) from at least one AP and at least one camera system. Based on these inputs, location information, identity information and/or behavioral attributes of tracked objects may be stored and/or analyzed. For example, analytics may be performed to determine patterns and/or anomalies as described above. In the context of the present example, system 200 includes an access point based location detection module 202, a video surveillance based location detection system 204, a geo-position data based mapping module 206, a tracking module 208, and an object assessment module 210.

According to one embodiment, access point based location detection module 202 can be configured to receive raw data (e.g., data extracted from a probe request or a connection request, including, but not limited to a signal strength indication and a MAC address) corresponding to objects within range of one or more APs of a venue's wireless network. From this data, access point based location detection module may form an association between the objects and their respective MAC addresses and calculate an estimate of locations for those of the objects of interest (e.g., based on their associated MAC addresses). Alternatively, access point based location detection module 202 may receive processed data (e.g., geo-position data) and associated identification data for an object in the vicinity of the wireless network. For example, geo-position data and identification data may be calculated or extracted by an AP or an AP controller. In an implementation, module 202 can be configured to, at periodic or pre-defined intervals or on a dynamic or on-demand basis, to receive (e.g., pushed by APs or pulled from APs) the raw or processed AP streams.

In one embodiment, video surveillance based location detection module 204 can be configured in a similar manner to receive raw data (e.g., in the form of video frames associated with one or more video feeds) and/or processed data (e.g., identification information for objects based on facial recognition or the like, and geo-position data corresponding to the objects) from at least one camera system. As above, module 204 may be configured to receive (e.g., pushed by video cameras or pulled from the video cameras) at periodic or pre-defined or dynamic or on an on-demand basis, video feeds of different areas of a venue capturing images of multiple objects within the venue.

Geo-position data based mapping module 206 can be configured to map the geo-position data received or otherwise derived from the AP stream(s) and the geo-position data received or otherwise derived from surveillance camera streams to a common coordinate system so that the received data streams can be evaluated and/or processed together.

Tracking module 208 can be configured to correlate an object reported in one set of geo-position data and match it with the same object reported in another set of geo-position data based on the unique identifier determined to be associated with the object. In an aspect, multiple objects of interest can be selected from the AP stream along with their corresponding location coordinates and unique identifiers, and the location coordinates can then be mapped through the common coordinate system to the location coordinates in the video streams (e.g., based on the known positioning and fields of view of the video surveillance cameras) based on the unique identifier of each object to help tag the users/objects of interest and monitor their activities, retrieve their previous activity history, their compliance history, their behavior history, among other parameters.

Object assessment module 210 can be configured to assess behavioral attributes of the correlated/tagged objects based on one or a combination of actions/activities of the object, geo-position data from one or both of the APs and the video surveillance cameras and the common coordinate system. Multiple other inputs (e.g., behavioral history of the tracked objects) can be taken into context while assessing behavioral attributes/imposing restrictions on the objects, or classifying their activities as anomalies, or taking any other action. Such historical/previous activities of the objects of interest can be extracted based on the unique identifier associated with the objects.

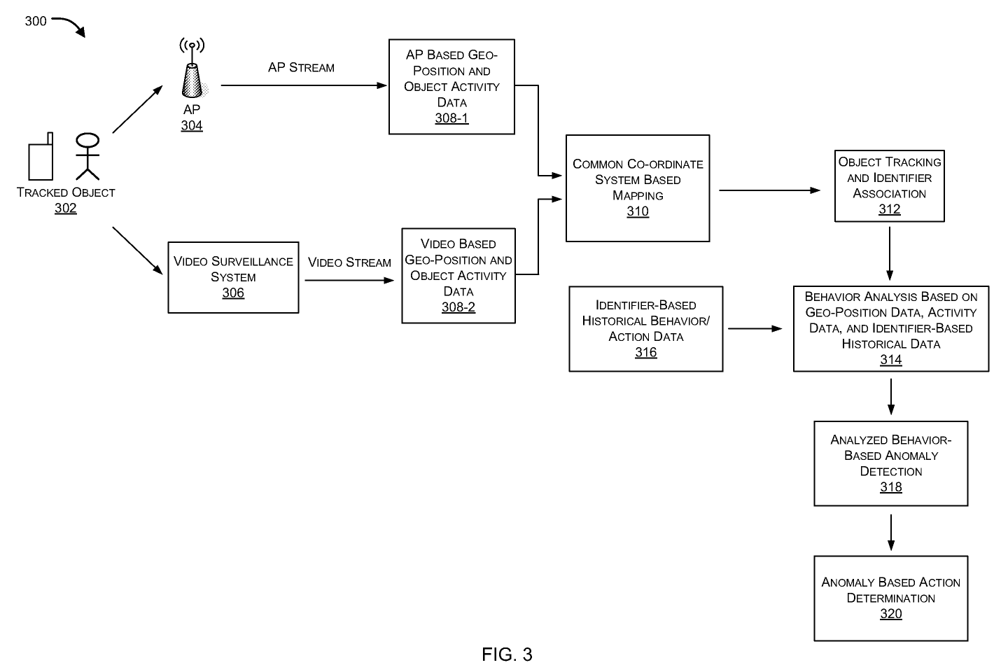

FIG. 3 illustrates an exemplary block diagram 300 showing location detection of an object, and behavior analysis thereof in accordance with an embodiment of the present invention. In the context of the present example, data streams (e.g., AP streams and video streams) are assumed to represent processed data streams representing the result of processing of raw data observed by, received by or otherwise captured by a video surveillance system 306 and/or an AP-based system (e.g., AP 304). As noted above, it is contemplated that location and behavioral attributes detection system (e.g., system 102, 200) may alternatively or additionally receive raw data from video surveillance systems and/or AP-based systems and may locally perform processing of such data (e.g., extracting unique identifiers associated with the tracked objects, deriving geo-position information and behavioral analysis)

In the present example, data streams having information about an object 302 such as a user/human being of interest can be received from one or more APs 304 and from one or more video surveillance systems 306. The AP stream can include AP-based geo-position information and object activity data 308-1. For example, the AP stream may include a unique identifier associated with object 302 along with object's location information. The video stream can include video-based geo-position information and object activity data 308-2. For example, the video stream can include one or more of video of the object for a defined time period and information derived therefrom, including, but not limited to identification information regarding object 302 and location information associated with object 302 based on known positions and fields of view of the respective video cameras of video surveillance system 306.

As described above, both the data streams 308-1 and 308-2 can be processed/mapped to a common coordinate system so as to facilitate co-relation of the information observed within and/or derived with respect to the two data streams 308-1 and 308-2. Once mapped to the common coordinate system, at block 312, a unique identifier of object 302 can be extracted from AP stream 308-1 and a location can be determined for object 302 based on the geo-position of object 302 determined based on the AP stream, the geo-position of object 302 determined based on the video steam or a combination thereof. The located object 302 can then be tagged or otherwise associated with the unique identifier so that all activity/behavior information associated with object 302 can be mapped/stored against the unique identifier. At block 314, behavior analysis of the object 302 can be conducted based on the activities/actions performed by the object 302 at the venue/store/location, historical data (retrieved from block 316) relating to the unique identifier, and geo-position data 308-1/308-2, or any other parameter. At block 318, based on the behavior analysis, an anomaly in the behavior, if any, can be detected, and at block 320, actions can be taken on the object 302 based on the detected anomaly.

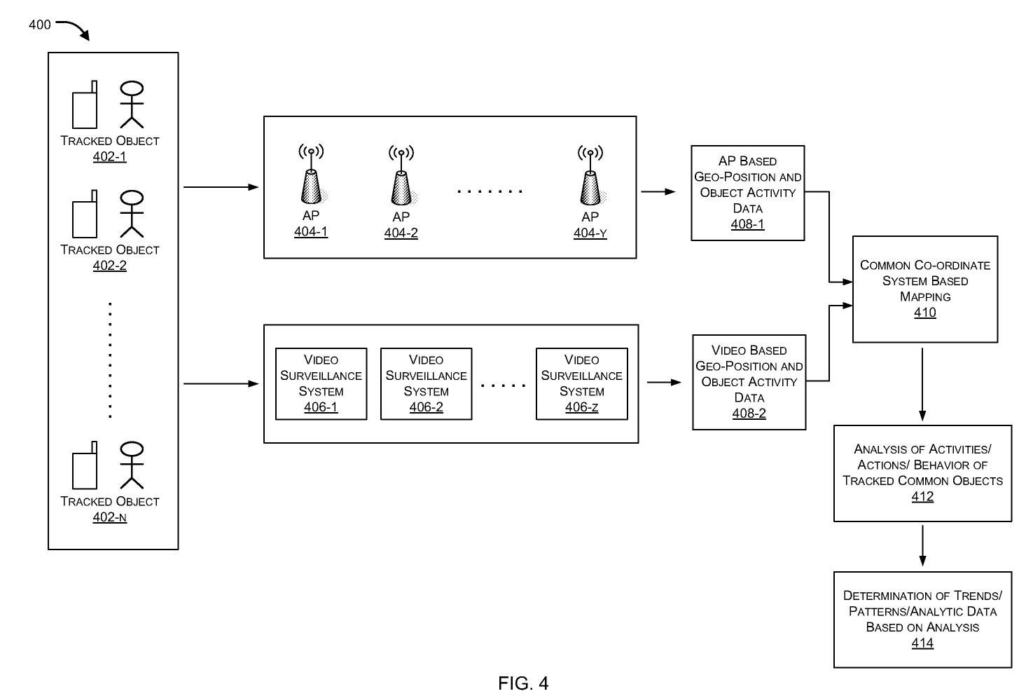

FIG. 4 illustrates an exemplary block diagram 400 showing location detection of one or more objects, and behavior analysis thereof in accordance with an embodiment of the present invention. As shown, data streams (AP streams and video streams) having information about one or more objects 402 (such as 402-1, 402-2, and so on) such as users/human beings of interest can be received from one or more APs 404 (such as 404-1, 404-2, and so on) and from one or more video surveillance systems 406 (such as 406-1, 406-2, and so on). AP streams can include unique identifiers associated with corresponding objects along with location information of the objects whereas video streams can include videos of the one or more objects 402 for a defined time period, wherein AP based geo-position and object activity data can be received at 408-1 and video based geo-position and object activity data can be received at 408-2. Both the data streams 408-1 and 408-2, at block 410, can be processed/mapped across a common coordinate system so as to align both the streams on a common location axis. Once mapped on the common coordinate system, objects of interest can be tracked in the video streams 408-2 based on the unique identifiers received from the AP streams 408-1, and behavior analysis can then be conducted on the tracked/mapped objects based on their actions, historical behavioral data, among other information received from the streams 408. Multiple patterns/trends (e.g., frequency and length of visits, congestion trends, purchase trends, billing trends, waiting times, peak hours, repeat visitors, number of visits, among others can be determined based on the analysis of the objects 402.

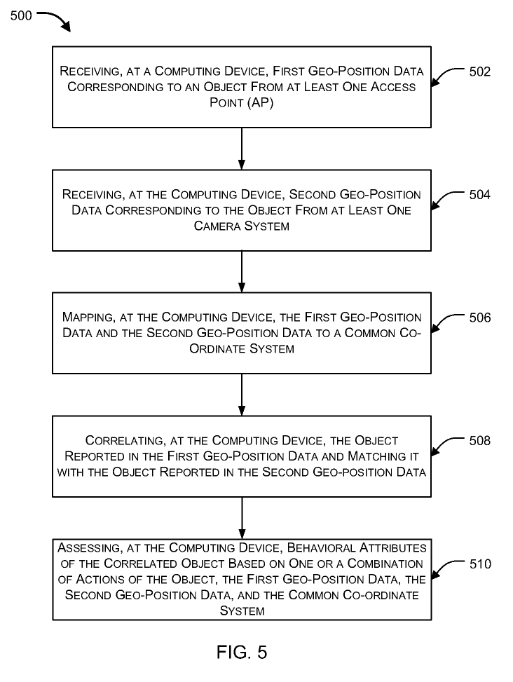

FIG. 5 illustrates an exemplary flow diagram 500 for detecting a location of an object, and analyzing behavioral attributes thereof in accordance with an embodiment of the present invention. At step 502, a computing device, on which methods of the present disclosure can be configured, receives (or derives based on raw data) a first geo-position data corresponding to an object from at least one Access Point (AP), wherein the first geo-position data can include a unique identifier for the object. At step 504, the computing device can receive (or derive based on raw data) second geo-position data corresponding to the object from at least one camera system, wherein the second geo-position data can include video feeds from the at least one camera system. At step 506, the computing device can map the first geo-position data and the second geo-position data to a common co-ordinate system. At step 508, object reported in the first geo-position data can be correlated/matched with the object reported in the second geo-position data based on the unique identifier for the object. At step 510, behavioral attributes of the correlated object can be assessed based on one or a combination of actions of the object, the first geo-position data, the second geo-position data, and the common co-ordinate system.

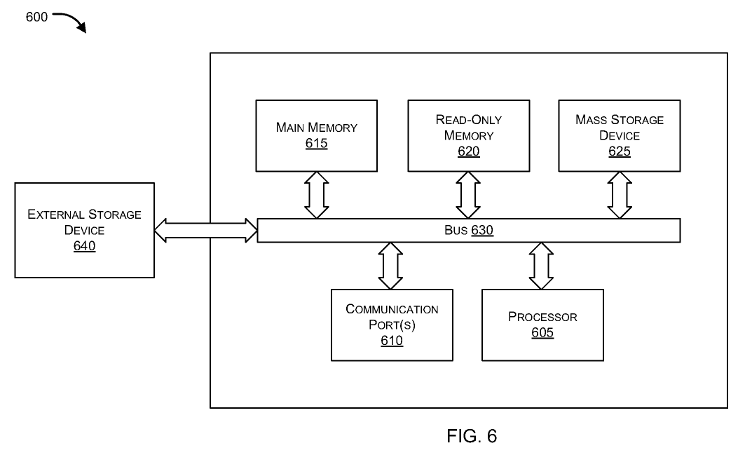

FIG. 6 is an exemplary computer system in which or with which embodiments of the present invention may be utilized. Embodiments of the present disclosure include various steps, which will be described in more detail below. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. Computer system 600 may represent one of potentially multiple computer systems forming part of location and behavioral attributes detection system 102, an AP-based tracking system, a video surveillance-based system (e.g., video surveillance system 306 or 406) or a computer system implementing one or more of the functional units illustrated by FIG. 2.

As shown, computer system 900 includes a bus 930, a processor 905, communication port 910, a main memory 915, a removable storage media 940, a read only memory 920 and a mass storage 925. A person skilled in the art will appreciate that computer system 900 may include more than one processor and communication ports.

Examples of processor 905 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 905 may include various modules associated with embodiments of the present invention.

Communication port 910 can be any of an RS-232 port for use with a modem based dialup connection, a 10/100 Ethernet port, a Gigabit or 10 Gigabit port using copper or fiber, a serial port, a parallel port, or other existing or future ports. Communication port 910 may be chosen depending on a network, such a Local Area Network (LAN), Wide Area Network (WAN), or any network to which computer system 900 connects.

Memory 915 can be Random Access Memory (RAM), or any other dynamic storage device commonly known in the art. Read only memory 920 can be any static storage device(s) such as, but not limited to, a Programmable Read Only Memory (PROM) chips for storing static information such as start-up or BIOS instructions for processor 905.

Mass storage 925 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 930 communicatively couples processor(s) 905 with the other memory, storage and communication blocks. Bus 930 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 905 to system memory.

Optionally, operator and administrative interfaces, such as a display, keyboard, and a cursor control device, may also be coupled to bus 930 to support direct operator interaction with computer system 900. Other operator and administrative interfaces can be provided through network connections connected through communication port 910.

Removable storage media 940 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

Components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

Some portions of the detailed description have been presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “determining”, “adjusting”, “applying”, “creating”, “ranking,” “classifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain embodiments of the present invention also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the invention should therefore be determined with reference to the appended claims, along with the full scope of equivalents to which such claims are entitled.

What is claimed is:

1. A system comprising:
an access point based location detection module configured to receive data from at least one Access Point (AP) of a wireless network of a venue, wherein the data includes (i) a unique identifier of an object and (ii) a first geo-position of the object or data from which the first geo-position can be derived;
a video surveillance based location detection module configured to receive from at least one camera system, monitoring a portion of the venue, one or more of a video feed captured by the at least one camera system and a second geo-position corresponding to the object;
a geo-position data based mapping module configured to map the first geo-position and the second geo-position to a common coordinate system;
a tracking module configured to correlate, based on the unique identifier for the object, information regarding the object as reported by the at least one AP or derived therefrom and match it with information regarding the object as reported by the at least one camera system or derived therefrom; and
an object assessment module configured to assess behavioral attributes of the correlated object based on one or a combination of actions of the object, the first geo-position, the second geo-position and the common coordinate system.

2. The system of claim 1, wherein the unique identifier of the object enables retrieval of behavioral history of the object for assessment of the behavioral attributes of the object.

3. The system of claim 1, wherein the unique identifier comprises a Media Access Control (MAC) address of a wireless computing device associated with the object, and wherein the MAC address is received from the wireless computing device by the at least one AP.

4. The system of claim 1, wherein the object comprises a human being, and wherein the wireless computing device comprises any or a combination of a mobile phone, a smartphone, a laptop, and wherein the wireless computing device transmits a management frame or a control frame to the at least one AP containing therein a MAC address of the wireless computing device.

5. The system of claim 3, wherein the first geo-position is calculated by the at least one AP or by the access point based location detection module using triangulation based on signal strengths associated with management or control frames originated by the wireless computing device and observed by a plurality of APs of the wireless network.

6. The system of claim 1, wherein analytics are performed on the video feed to one or more of identify and locate the object and assess the object's behavior.

7. The system of claim 6, wherein the unique identifier for the object is extracted from the data received from the at least one AP, and wherein the unique identifier is used to facilitate the analytics on the video feed.

8. The system of claim 1, wherein one or more actions are performed on the object based on the assessed behavioral attributes.

9. The system of claim 1, wherein responsive to detecting one or more anomalies based on the assessed behavioral attributes, at least one restriction is imposed on the object.

10. The system of claim 1, wherein the object assessment module is further configured to determine behavioral attributes of a plurality of objects within the venue along with one or a combination of assessment of concentration attributes of the plurality of objects, and action-based attributes of the plurality of objects.

11. A method comprising:
receiving, by one or more computer systems of a location and behavioral attribute detection system, data from at least one Access Point (AP) of a wireless network of a venue, wherein the data includes (i) a unique identifier of an object and (ii) a first geo-position of the object or data from which the first geo-position can be derived;
receiving, by the one or more computer systems, one or more of a video feed captured by at least one camera system monitoring a portion of the venue and a second geo-position corresponding to the object;
mapping, by the one or more computer systems, the first geo-position and the second geo-position to a common coordinate system;
correlating, by the one or more computer systems, based on the unique identifier for the object, information regarding the object as reported by the at least one AP or derived therefrom and information regarding the object as reported by the at least one camera system or derived therefrom; and
assessing behavioral attributes of the correlated object based on one or a combination of actions of the object, the first geo-position, the second geo-position and the common coordinate system.

12. The method of claim 11, wherein the unique identifier enables retrieval of behavioral history of the object for assessment of the behavioral attributes of the object.

13. The method of claim 11, wherein the unique identifier comprises a Media Access Control (MAC) address of a wireless computing device associated with the object, and wherein the MAC address is received from the wireless computing device by the at least one AP.

14. The method of claim 11, wherein the object comprises a human being, and wherein the wireless computing device comprises any or a combination of a mobile phone, a smartphone, a laptop, and wherein the wireless computing device transmits a management frame or a control frame to the at least one AP containing therein a MAC address of the wireless computing device.

15. The method of claim 13, wherein the first geo-position is calculated by the at least one AP or by the access point based location detection module using triangulation based on signal strengths associated with management or control frames originated by the wireless computing device and observed by a plurality of APs of the wireless network.

16. The method of claim 11, wherein analytics are performed on the video feed to one or more of identify and locate the object and assess the object's behavior.

17. The method of claim 6, wherein the unique identifier for the object is extracted from the data received from the at least one AP, and wherein the unique identifier is used to facilitate the analytics on the video feed.

18. The method of claim 11, further comprising responsive to detecting one or more anomalies based on the assessed behavioral attributes, imposing at least one restriction on the object.

19. The method of claim 11, further comprising determining, by the one or more computer systems, behavioral attributes of a plurality of objects within the venue along with one or a combination of assessment of concentration attributes of the plurality of objects, and action-based attributes of the plurality of objects.
